(19) United States
(12) Patent Application Publication
(10) Pub. No.: US 2013/0214228 A1
(43) Pub. Date: Aug. 22, 2013

(54) Baluster Bracket Assembly

(71) Applicant: Jayme M. Sneith, Scenery Hill, PA (US)

(72) Inventor: Jayme M. Sneith, Scenery Hill, PA (US)

(21) Appl. No.: 13/400,262

(22) Filed: Feb. 20, 2012

(51) Int. Cl. E04F 11/18; B23P 11/00

(52) U.S. Cl. 256/65.07; 256/65.03; 29/428

(57) ABSTRACT

A baluster bracket assembly including a pair of mounting brackets attached to facing surfaces of a handrail and a baserail for retaining a baluster in railing construction. Each mounting bracket includes a mounting plate fastened to the railing surface and a collar for receiving an end of the baluster. A shoe is provided with each mounting bracket for attachment to the end of the baluster and for covering the mounting bracket after installation.

### RELATED APPLICATIONS

Not Applicable.

### FIELD OF THE INVENTION

The present invention relates generally to railing construction, and in particular, to a baluster bracket assembly for the attachment of balusters between handrails and baserails in applications utilizing railing systems.

### BACKGROUND OF THE INVENTION

A requirement for almost all walking-working surfaces is that every open-sided floor or platform four feet (4 ft.) or more above adjacent floor or ground level shall be guarded by a railing on all open sides, except where there is an entrance to a ramp, stairway, or fixed ladder. The open space between a handrail and the floor surface is often filled by a plurality of spaced apart balusters. Most installers prefer to install balusters after the handrail is installed. The general consensus is that it is easier to adjust baluster position to fit the handrail than it is to measure, cut, fit, and attach both the handrail and the balusters at the same time.

Whether using metal or wooden balusters, traditionally holes are drilled into the baserail or floor surface and into the handrail at the appropriate spacing for receiving the ends of the baluster. At least one (1) of the holes in the support rails, typically that of the baserail, is drilled deep and the baluster is cut longer than necessary in order to fit within the set space between the handrail and the baserail. Once positioned within the prepared holes, the baluster must be glued or epoxied within the drilled hole and left for a minimum of twenty-four hours (24 hrs.) to dry. The baluster must then be secured into position while the glue or epoxy dries. This process is messy. Furthermore if the baluster shifts position before the glue has dried, the glue must be chiseled out and the baluster must be removed and reattached. Other difficulties occur due to end ends of most balusters having a square cross-sectional shape, which force the installer to drill holes large enough to receive the square end or chisel out a square hole. Each of these solutions presents significant drawbacks.

Additionally, if at any time the balusters become damaged or need to be replaced, the baluster must be cut out from the railing system and the ends removed from the holes. This process can likely damage both the handrail and the baserail causing additional problems.

Addressing these problems has provided various attachment assemblies intended to support railing systems and attach balusters or similar support posts. Unfortunately, the hardware and methods presently available still require the drilling of large holes or utilize mechanical fasteners that are exposed, which can be unsightly and diminish the appearance of the otherwise decorative railing system.

### SUMMARY OF THE INVENTION

The inventor has recognized the aforementioned inherent problems and lack in the art and observed that there is a need for a device and method to attach balusters between handrails and baserails which does not require the drilling of large holes and glue or otherwise detracts from the appearance of the railing system. Additionally, a device and method is needed which reduces the cost and labor involved in the construction, repair, and replacement of railing systems.

The inventor has addressed this need by developing a baluster mounting bracket for use during installation of balusters. Accordingly, it is an object of the present embodiments of the invention to provide a baluster mounting bracket for attaching a baluster to a railing system. The mounting bracket includes a mounting plate having a rail mounting surface and a baluster mounting surface. The rail mounting surface being adapted for attachment to a railing surface. The mounting bracket also includes a collar disposed on the baluster mounting surface which is adapted to receive a baluster. The collar has sidewalls with an open side and defines an interior area. The open side is adapted for insertably receiving an end of the baluster and the interior area has a shape adapted to correspond to a cross-sectional shape of the end of the baluster.

Another object of the invention is to provide a shoe for covering the mounting bracket once installed. The shoe includes a decorative exterior body having an open top end and an open bottom end. A hollow channel extends entirely through the body and is adapted for receiving the end of the baluster. The open bottom end covers the mounting bracket and is angled such that the open top end is parallel to the collar.

Another object of the invention is to provide the mounting bracket such that balusters are vertically oriented in relation to the handrail and baserail. In certain embodiments, the sidewalls extend outwardly and perpendicularly from the mounting plate and are adapted to retain the baluster perpendicular relative to the mounting plate. In certain other embodiments, the sidewalls extend outwardly and angularly from the mounting plate and are adapted to retain the baluster at an angle other than perpendicular relative to the mounting plate.

In certain embodiments, the invention has addressed this need by providing a baluster bracket assembly for use during railing construction. The baluster bracket assembly includes a plurality of mounting brackets, shoes, and balusters for fastening the plurality of baluster between facing surfaces of the handrail and the baserail.

Furthermore, the described features and advantages of the disclosure may be combined in various manners and embodiments as one skilled in the relevant art will recognize. The disclosure can be practiced without one (1) or more of the features and advantages described in a particular embodiment.

Further advantages of the present disclosure will become apparent from a consideration of the drawings and ensuing description.

### BRIEF DESCRIPTION OF THE DRAWINGS

The advantages and features of the present disclosure will become better understood with reference to the following more detailed description and claims taken in conjunction with the accompanying drawings, in which like elements are identified with like symbols, and in which:

FIG. 1 is an environmental view of a plurality of baluster bracket assemblies depicted in stair and railing construction in accordance with the present invention;

FIG. 2 is an exploded view of the baluster bracket assembly;

FIG. 3 is a transparent side view of the baluster bracket assembly depicted in an assembled state;

FIG. 4 is perspective view of a mounting bracket having a perpendicular collar;

FIG. 5 is a cross section view of a the mounting bracket of FIG. 4 depicted with a covering shoe;

FIG. 6 is a perspective view of the mounting bracket having a sloped collar;

FIG. 7 is a cross section view of the mounting bracket of FIG. 6 depicted with a covering shoe;

FIG. 8 is a fragmented side view of the baluster bracket assembly depicted in use on a horizontal handrail and a horizontal baserail;

FIG. 9 is a fragmented side view of the baluster bracket assembly depicted in use on a sloped handrail and a horizontal baserail; and,

FIG. 10 is a fragmented side view of the baluster bracket assembly depicted in use on a sloped handrail and a sloped baserail;

### DESCRIPTIVE KEY

10 baluster bracket assembly
20 mounting bracket
20a perpendicular mounting bracket
20b sloped mounting bracket
21 mounting plate
22 rail mounting surface
23 baluster mounting surface
24 collar
24a perpendicular collar bracket
24b sloped collar bracket
25 interior area
26 open side
27 fastening aperture
28 set screw aperture
29 sidewalls
30 baluster
31 upper end
32 lower end
33 fastening aperture
40 shoe
40a perpendicular shoe
40b sloped shoe
41 channel
42 open top end
43 open bottom end
44 fastening aperture
50 threaded fastener
51 set screw
100 handrail
102 baserail

### DETAILED DESCRIPTION OF THE PREFERRED EMBODIMENT

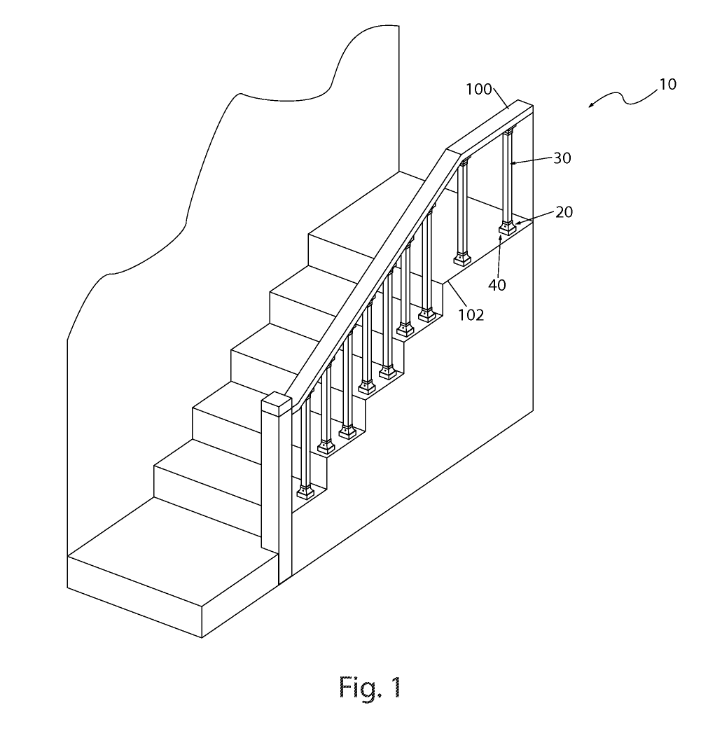

In accordance with the invention, the best mode is presented in terms of a preferred embodiment, herein depicted within FIGS. 1 through 10. However, the disclosure is not limited to a single described embodiment and a person skilled in the art will appreciate that many other embodiments are possible without deviating from the basic concept of the disclosure and that any such work around will also fall under its scope. It is envisioned that other styles and configurations can be easily incorporated into the teachings of the present disclosure, and only one particular configuration may be shown and described for purposes of clarity and disclosure and not by way of limitation of scope.

The terms “a” and “an” herein do not denote a limitation of quantity, but rather denote the presence of at least one of the referenced items.

Referring now to FIGS. 1 through 10, depicting a baluster bracket assembly (herein described as a “device”) 10 and a method of use thereof, where like reference numerals represent similar or like parts. In accordance with the invention, the present disclosure describes the device 10 for attaching a baluster between a handrail 100 and a stair, floor, or similar baserail 102 during stair construction.

Referring to FIG. 1, a plurality of devices 10 is used for railing construction for inside and outside staircases, landings, balconies, decks, and any other type of platforms that require a form of barrier for safety or cosmetic reasons. The devices 10 are used to attach a plurality of balusters or spindles 30 (the term baluster is used throughout this disclosure) which act as an infill between the handrail 100 and the baserail 102. In the embodiment illustrated in FIG. 1, the baserail 102 is the outer stringer of a staircase. It can be appreciated that the baserail 102 can also be the tread or horizontal top surface of the steps if used with a cut or open stringer or a landing or floor surface if used on a deck or balcony.

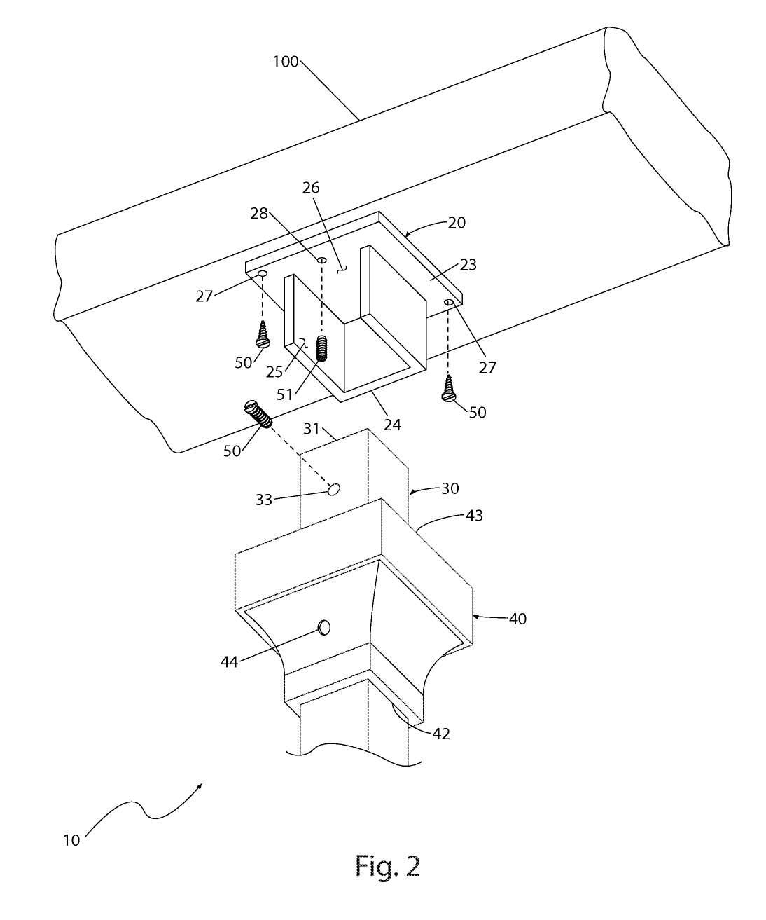

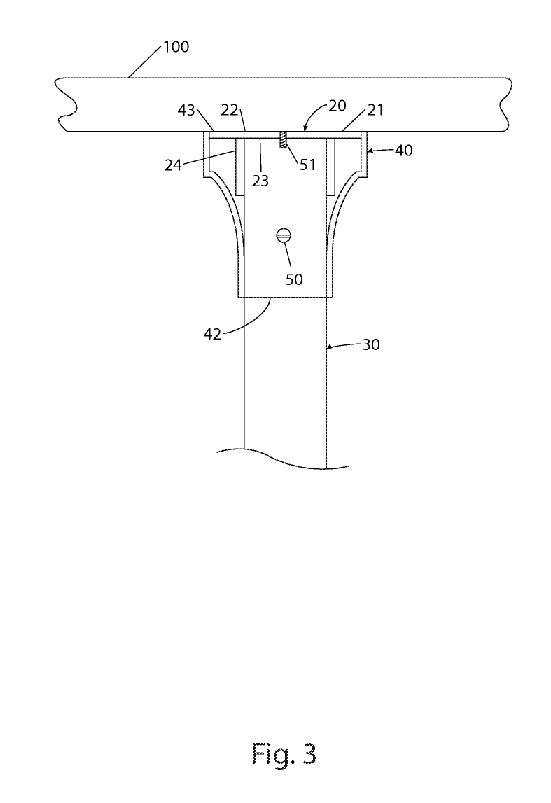

Referring to FIGS. 2 and 3, the device 10 generally includes a mounting bracket 20 which receives and supports a baluster 30 between the support rails 100, 102 and a shoe 40 for covering the mounting bracket 20. A first mounting bracket 20 is fastened to an underside of the handrail 100 and a second mounting bracket 20 is fastened to an opposing top surface of the baserail 102 for joining each baluster 30. It can be appreciated that a railing system typically includes a plurality of spaced apart balusters 30 and each baluster 30 would utilize a pair of mounting brackets 20 and shoes 40 and that only a single baluster 30 and a single pair of mounting brackets 20 and shoes 40 are disclosed in any given illustrated embodiment since each assembly is identical with the others. The configuration illustrated in FIG. 2 as used with a handrail 100 is identical to the configuration as used with a horizontal baserail 102 (not shown in FIG. 2).

Referring to FIGS. 2 through 7, the mounting bracket 20 includes a generally flat mounting plate 21 having a rail mounting surface 22 and a baluster mounting surface 23. A collar 24 extends outwardly from the baluster mounting surface 23. The mounting brackets 20 can be made from any suitable durable and lightweight material, such as metal or polystyrene plastic in a stamping or molding process. The collar 24 is generally disposed at a central location upon the baluster mounting surface 23. The collar 24 includes sidewalls 29 defining and interior area and an open side 26 for insertably receiving an end of the baluster 30. In the illustrated embodiments, the sidewalls 29 include a three-sided sidewall forming a generally square cross-sectional shape.

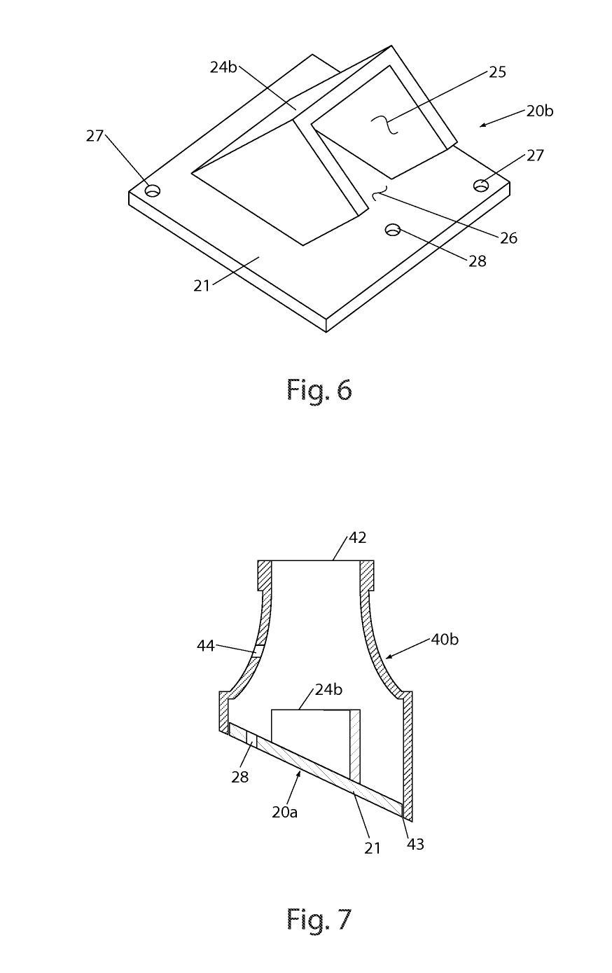

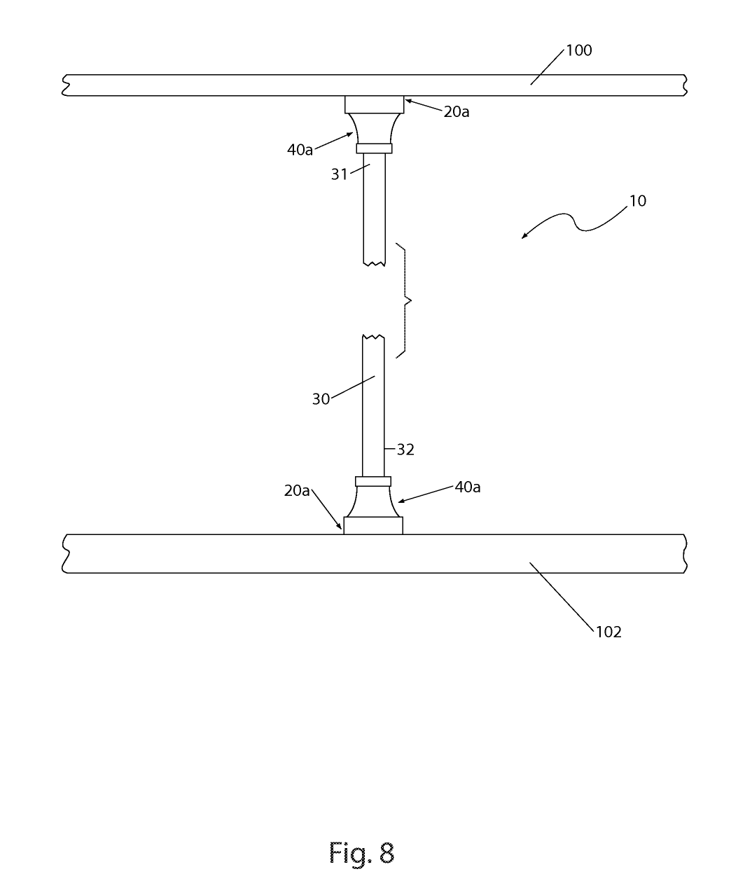

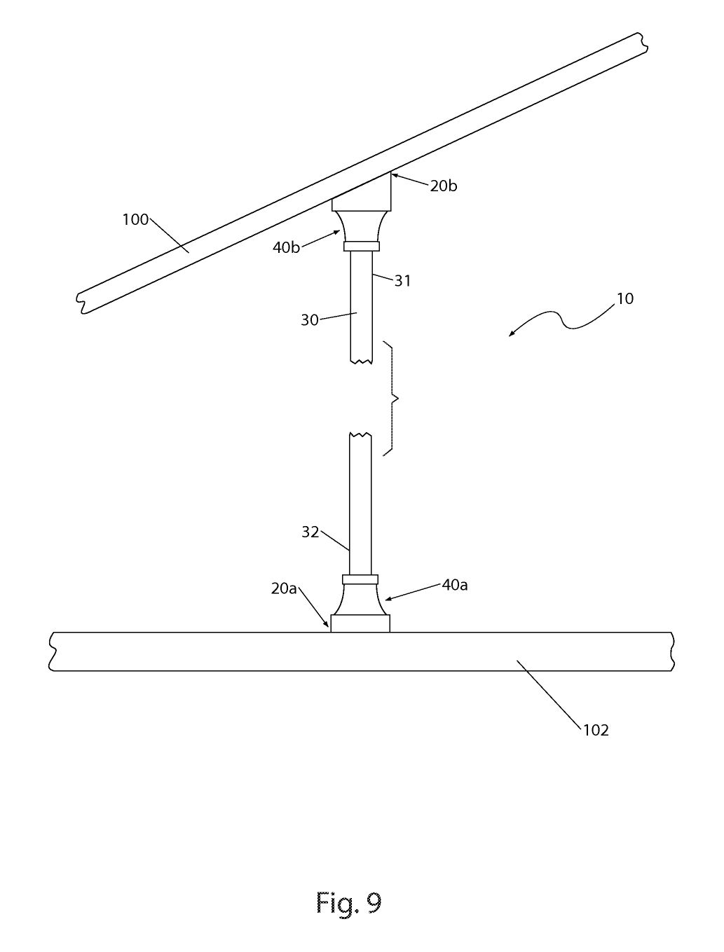

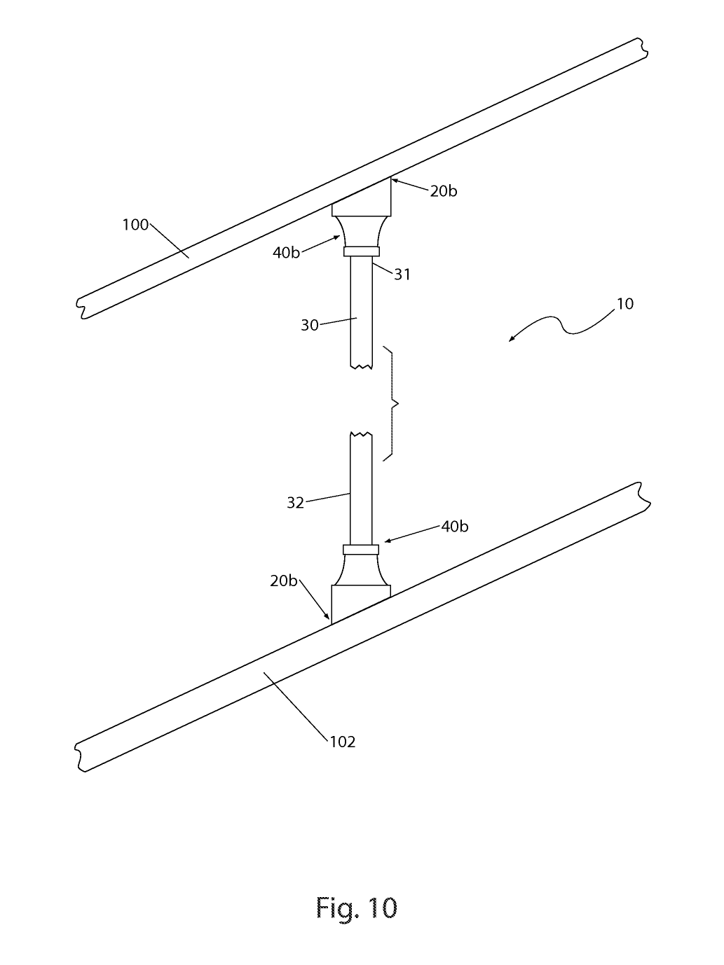

As best seen in FIGS. 2 through 5 in certain embodiments of a perpendicular mounting bracket 20a, the walls of the collar 24 are perpendicular to the mounting plate 21. The orientation of this perpendicular collar bracket 24a provides for attaching vertical balusters 30 between horizontal handrails 100 and horizontal baserails 102, as shown in FIG. 8. As best seen in FIGS. 6 and 7 in certain embodiments of a sloped mounting bracket 20b, the walls of the collar 24 are sloped at angles other than perpendicular with respect to the mounting plate 21. The preferred angle of this sloped collar bracket 24b is approximately thirty-one degrees (31°). The orientation of the sloped collar bracket 24b provides for attaching vertical balusters 30 between sloped handrails 100 and sloped baserails 102, as shown in FIG. 10. As shown in FIG. 9, a combination of a perpendicular mounting bracket 20a having a perpendicular collar bracket 24a and a sloped mounting bracket 20b having a sloped collar bracket 24b can be used for attaching vertical balusters 30 between sloped handrails 100 and horizontal baserails 102.

The interior area 25 of the collar 24 has substantially the same configuration and size as the exterior surface of the end portions of the baluster 30 and is sufficient to receive three (3) sides of the baluster 30. The collar 25 and interior area 25 are illustrated having a square shape, as most typical balusters 30 have an upper end 31 and a lower end 32 having a square cross-sectional shape. However, it can be appreciated that the sidewalls 29 of the collar 24 and interior area 25 may have various sizes and shapes depending on the particular baluster 30 being used. An open side of the collar 24 allows the ends 31, 32 of the baluster 30 to slide in to and out from the mounting bracket 20 when joining of the baluster 30.

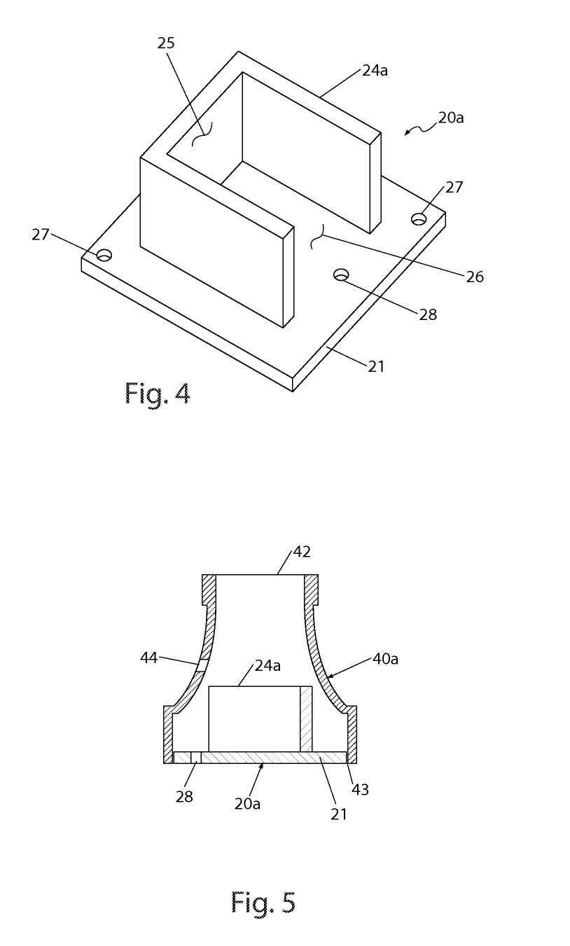

The shoe 40 includes a decorative exterior and a through channel 41 entirely along a longitudinal axis. The exterior shape and design of the shoe 40 can vary greatly and as such the illustrated embodiment should not be viewed as a limiting factor. The shoe 40 has an open top end 42 and an open bottom end 43 for providing access to the channel 41 by the baluster 30. The open top end 42 is suitably sized and shaped to receive the end portion 31, 32 of the baluster 30, which can pass entirely through the channel 41 and extend out from the open bottom end 43. The open bottom end 43 is suitably sized and shaped to receive and cover the bracket plate 21 and collar 24. The shoe 40 retains the respective end 31, 32 of the baluster 30 within the collar 24 once positioned over and to cover the mounting bracket 20. The shoe 40 includes a fastening aperture 44 that receives a threaded fastener 50 which extends through a sidewall and is threadingly fastened to another fastening aperture 33 disposed in the end 31, 32 of the baluster 30 when the fastening apertures 33, 44 are aligned. As best seen in FIGS. 4 and 5, a perpendicular shoe 40a is used with the perpendicular mounting bracket 20a having the perpendicular collar bracket 24a and includes a flat bottom end. As best seen in FIGS. 6 and 7, a sloped shoe 40b is used with the sloped mounting bracket 20b having the sloped collar bracket 24b and includes a sloped bottom end for adequately receiving the sloped collar bracket 24b and aligning with the angled mounting surface and the vertical baluster 30.

The mounting bracket 20 also includes a plurality of fastening apertures 27 formed in opposing corners of the mounting plate 21. The fastening apertures 27 receive threaded fasteners 50 which extend through the mounting plate 21 and are screwed into the underside surface of the handrail 100 or the top surface of the baserail 102 to the secure the mounting bracket 20 thereto, respectively. The mounting brackets 20 are fastened to the respective rails 100, 102 for securely joining the balusters 30 and the collars 24 prevent movement and rotation of the balusters 30. The mounting bracket also includes at least one set screw aperture 28 formed in the mounting plate 21 adjacent to the open side 26 of the collar 24. The set screw aperture 28 receives a threaded set screw 51 which at least partially protrudes from the mounting plate 21 and provides an additional physical barrier to prevent the baluster 30 from disengaging from within the collar 24.

Only a simple square baluster 30 has been illustrated in the various drawings, however, the baluster 30 can be provided in various lengths, diameters, and styles having various different exterior shapes and designs. The balusters 30 can also be made of various suitable materials.

It can be appreciated by one skilled in the art that other styles and configurations of the invention can be easily incorporated into the teachings of the present disclosure and only two (2) particular configurations have been shown and described for purposes of clarity and disclosure and not by way of limitation of scope.

In accordance with the invention, the device 10 can be utilized by the user in a simple and effortless manner with little or no training. After initial purchase or acquisition of the device 10, it is installed and utilized as indicated in FIGS. 1 through 10.

The method of installing and utilizing the device 10 can be achieved by performing a series of steps. It can be appreciated that the steps described can be performed in alternative order and as such should not be viewed as a limiting factor.

Referring to FIGS. 1 through 10, the device 10 can be used in stair and handrail construction of various styles, including horizontal and sloped mounting surfaces. During construction of stairs, the newel post and handrail 100 are attached to a main support structure. A first plurality of mounting brackets 20 is fastened to the top surface of the baserail 102 in a spaced apart fashion in accordance with the distance between the balusters 30. For horizontal baserails 102, a plurality of mounting brackets 20 having perpendicular collar brackets 24a is used. For sloped baserails 102, a plurality of mounting brackets 20 having sloped collar brackets 24b is used. A second plurality of mounting brackets 20 is fastened to the bottom surface of the handrail in a spaced apart fashion in accordance with the distance between the balusters 30 and aligned with the first plurality of mounting brackets 20. For horizontal handrails 100, a plurality of mounting brackets 20 having perpendicular collar brackets 24a is used. For sloped handrails 100, a plurality of mounting brackets 20 having sloped collar brackets 24b is used.

A plurality of balusters 30 are coupled to the opposing pairs of mounting brackets 20 and joined between the handrail 100 and the baserail 102. Each baluster 30 is cut to the correct length required to span the distance between the handrail 100 and the baserail 102. Balusters 30 coupled to perpendicular collar brackets 24a have perpendicular cuts. Balusters 30 coupled to sloped collar brackets 24b have angled cuts.

Once cut to the appropriate length a pair of shoes 40 is slidably connected over each baluster 30. An upper end 31 of the baluster 30 is inserted into the collar 24 of the mounting bracket 20 fastened to the handrail 100 and the lower end 32 is inserted into the collar 24 of the mounting bracket 20 fastened to the baserail 102. Once inserted, the set screws 51 is partially inserted into the set screw apertures 28 of both mounting brackets 20 to retain the baluster 30 within the collars 24. Each shoe 40 is positioned over the mounting bracket 20 and is fastened to the baluster 30 by aligning the fastening apertures 33, 44 and inserting a fastener 50.

Mounting brackets 20 having perpendicular collar brackets 24a are preferably fastened to the handrail 100 and baserail 102, such that the open side 26 of the collar 24 is facing inwardly toward the stairs, landing, or other walking surface for increased safety.

The foregoing descriptions of specific embodiments have been presented for purposes of illustration and description. They are not intended to be exhaustive or to limit the invention and method of use to the precise forms disclosed. Various modifications and variations can be appreciated by one skilled in the art in light of the above teachings. The embodiments have been chosen and described in order to best explain the principles and practical application in accordance with the invention to enable those skilled in the art to best utilize the various embodiments with expected modifications as are suited to the particular use contemplated. It is understood that various omissions or substitutions of equivalents are contemplated as circumstance may suggest or render expedient, but is intended to cover the application or implementation without departing from the spirit or scope of the claims of the invention.

1. A baluster mounting bracket for attaching a baluster to a railing system comprising:
a mounting plate comprising rail mounting surface and a baluster mounting surface adapted for attachment to a railing surface; and,
a collar disposed on said baluster mounting surface and adapted to receive a baluster, said collar comprising three sidewalls, an open side, and an open top defining an interior area, wherein said three sidewalls comprises a pair of laterally opposed sidewalls and a sidewall extending between said pair of laterally opposed sidewalls.

2. The bracket of claim 1,
wherein said open side is adapted for insertably receiving an end of said baluster and said interior area comprises a shape adapted to correspond to a cross-sectional shape of said end of said baluster such that said three sidewalls contact three sides of said end of said baluster.

3. The bracket of claim 21, wherein each of said three sidewalls extend outwardly and perpendicularly from said mounting plate such that said collar retains said baluster perpendicularly relative to said mounting plate.

4. The bracket of claim 3, further comprising a shoe comprising:
a decorative exterior body comprising an open top end and an open bottom end; and,
a hollow channel extending entirely through said body and adapted for receiving a shaft of said baluster;
wherein said open bottom end covers said mounting bracket plate and said collar.

5. The bracket of claim 4, further comprising a pair of fastening apertures disposed through said mounting plate adapted for receiving fasteners for fastening said baluster mounting bracket to a handrail or a baserail surface.

6. The bracket of claim 5, further comprising a set screw aperture disposed through said mounting plate adjacent to said open side of said collar for partially receiving a set screw, said set screw being adapted to retain said end of said baluster within said collar.

7. The bracket of claim 6, wherein said shoe further comprises a fastening aperture disposed through a side of said body and adapted for receiving a fastener for attaching said shoe to said baluster.

8. The bracket of claim 21, wherein said pair of laterally opposed sidewalls extend outwardly and perpendicularly from said mounting plate and said sidewall extending between said laterally opposed sidewalls extends outwardly at an angle less than 90° relative to said mounting plate such that said collar retains said baluster at an angle less than perpendicular relative to said mounting plate.

9. The bracket of claim 8, further comprising a shoe comprising:
a decorative exterior body comprising an open top end and an open bottom end; and,
a hollow channel extending entirely through said body and adapted for receiving a shaft of said baluster;
wherein said open bottom end covers said mounting bracket and is angled such that said open top end is parallel to said collar.

10. The bracket of claim 9, further comprising a pair of fastening apertures disposed through said mounting plate adapted for receiving fasteners for fastening said baluster mounting bracket to a handrail or a baserail surface.

11. The bracket of claim 10, further comprising a set screw aperture disposed through said mounting plate adjacent to said open side of said collar for partially receiving a set screw, said set screw being adapted to retain said end of said baluster within said collar.

12. The bracket of claim 11, wherein said shoe further comprises a fastening aperture disposed through a side of said body and adapted for receiving a fastener for attaching said shoe to said baluster.

13. A baluster bracket assembly comprising:
a baluster comprising an upper end, a lower end, and a shaft between said upper end and said lower end;
a first mounting bracket for receiving said lower end of said baluster and adapted for fastening to a top surface of a baserail;
a second mounting bracket for receiving said upper end of said baluster and adapted for fastening to a bottom surface of a handrail;
a first shoe slidably coupled to said lower end of said baluster for covering said first mounting bracket; and,
a second shoe slidably coupled to said upper end of said baluster for covering said second mounting bracket.

14. The bracket assembly of claim 13, wherein said first and second mounting bracket each further comprises:
a mounting plate comprising rail mounting surface and a baluster mounting surface; and,
a collar disposed on said baluster mounting surface and further comprises sidewalls having an open side and defining an interior area;
wherein said open side is adapted for insertably receiving either said upper or lower end of said baluster and said interior area comprises a shape corresponding to a cross-sectional shape of said upper or lower end of said baluster.

15. The bracket assembly of claim 14, wherein said first and second shoe each further comprises:
a decorative exterior body comprising an open top end and an open bottom end; and,
a hollow channel extending entirely through said body for receiving a shaft of said baluster;
wherein said open bottom end covers said mounting bracket plate and collar and is angled such that said open top end is parallel to said collar.

16. The bracket assembly of claim 15, wherein said sidewalls extend outwardly and perpendicularly from said mounting plate for retaining said baluster perpendicular relative to said mounting plate.

17. The bracket assembly of claim 16, wherein said mounting bracket further comprises:
a pair of fastening apertures disposed through said mounting plate adapted for receiving fasteners for fastening said mounting bracket to said handrail or said baserail surface;
a set screw aperture disposed through said mounting plate adjacent to said open side of said collar for partially receiving a set screw, said set screw for retaining said end of said baluster within said collar; and,
wherein said shoe further comprises a fastening aperture disposed through a side of said body and for receiving a fastener for attaching said shoe to said baluster.

18. The bracket of claim 15, wherein said sidewalls extend outwardly and angularly from said mounting plate for retaining said baluster at an angle other than perpendicular relative to said mounting plate.

19. The bracket assembly of claim 18, wherein said mounting bracket further comprises:
a pair of fastening apertures disposed through said mounting plate adapted for receiving fasteners for fastening said mounting bracket to said handrail or said baserail surface;
a set screw aperture disposed through said mounting plate adjacent to said open side of said collar for partially receiving a set screw, said set screw for retaining said end of said baluster within said collar; and,
wherein said shoe further comprises a fastening aperture disposed through a side of said body and for receiving a fastener for attaching said shoe to said baluster.

20. A method of fastening a baluster to a railing assembly, said method comprising the steps of:
providing at least one baluster comprising an upper end, a lower end, and a shaft between said upper end and said lower end;
providing at least one pair of mounting brackets, each comprising a mounting plate having a rail mounting surface and a baluster mounting surface and a collar disposed on said baluster mounting surface comprising sidewalls having an open side and defining an interior area;
providing at least one pair of shoes, each comprising a decorative exterior body having an open top end and an open bottom end and a hollow channel extending entirely through said body for receiving said shaft of said baluster;
providing a baserail;
providing a handrail disposed above said baserail;
fastening a first one of said pair of mounting brackets to a top surface of said baserail;
fastening a second one of said pair mounting brackets to a bottom surface of said handrail and aligned with said first one of said pair of mounting brackets;
inserting said upper and lower ends of said baluster within said interior area of said collar of each of said pair of mounting brackets; and,
covering each of said pair of mounting brackets with said pair of shoes.
